(19) United States
(12) Patent Application Publication
(10) Pub. No.: US 2026/0309682 A1
(43) Pub. Date: Oct. 8, 2026

(54) PROPANE-POSITION CARBON ISOTOPE TESTING METHOD AND TESTING SYSTEM

(71) Applicants: CHINA PETROLEUM & CHEMICAL CORPORATION, Beijing (CN); SINOPEC EXPLORATION & PRODUCTION RESEARCH INSTITUTE, Beijing (CN)

(72) Inventors: Yuanyuan MA, Beijing (CN); Cheng TAO, Beijing (CN); Changbo ZHAI, Beijing (CN); Zhirong ZHANG, Beijing (CN); Li LU, Beijing (CN); Luyun LI, Beijing (CN); Kewei XU, Beijing (CN)

(21) Appl. No.: 19/480,228

(22) PCT Filed: Apr. 30, 2024
(86) PCT No.: PCT/CN2024/090790

§ 371 Date: Oct. 30, 2025

(30) Foreign Application Priority Data
May 6, 2023 (CN) 202310505295.7

(51) Int. Cl. G01N 30/12; C10L 3/10; G01N 30/46; G01N 30/68; G01N 30/72

(52) U.S. Cl. CPC G01N 30/12; C10L 3/10; G01N 30/46; G01N 30/68; G01N 30/7206; G01N 2030/125

(57) ABSTRACT

A method for testing position-specific carbon isotope of propane and a system for testing position-specific carbon isotope of propane are provided. The method for testing position-specific carbon isotope of propane includes steps of: S1, extracting propane; S2, causing the propane to undergo complete pyrolysis; S3, separating pyrolysis products of the propane; and S4, calculating position-specific carbon isotope values of the propane based on carbon isotope values of the pyrolysis products of the propane.

### CROSS REFERENCE OF RELATED APPLICATIONS

The present application claims the priority of Chinese patent application No. 202310505295.7 entitled “A PYROLYSIS-BASED POSITION-SPECIFIC CARBON ISOTOPE OF PROPANE TESTING SYSTEM AND TESTING METHOD” and filed on May 6, 2023, the entire content of which is incorporated herein by reference.

### TECHNICAL FIELD

The present invention relates to the technical field of oil and gas chemical analysis, and specifically to a method for testing position-specific carbon isotope of propane and a system for testing position-specific carbon isotope of propane.

### TECHNICAL BACKGROUND

Intramolecular position-specific carbon isotope (“position-specific carbon isotope” for short) analysis is a newly emerging technology after stable carbon isotope. Position-specific carbon isotope of propane as one of the current research hot spots provides a new idea for the research on natural gas.

A non-patent literature “Determination of position-specific carbon isotope ratios of propane from natural gas” (Yun Li, et al., Organic Geochemistry, February 2018) discloses an apparatus and method for testing position-specific carbon isotope of propane from natural gas. In the experiments according to the technology provided in the above literature, the pyrolysis rate of propane is about 50%. Incomplete pyrolysis leads to the isotope fractionation effect. In this case, a series of complex calculations needs to be performed before the position-specific carbon isotope of propane can be calculated. The calculation is affected by the isotope fractionation effect, which leads to inaccurate calculation results. Therefore, the current procedure for testing the position-specific carbon isotope of propane is cumbersome and the calculation results thereof are inaccurate.

Due to the low pyrolysis rate of the propane, the ¹²C molecules in the propane will be pyrolyzed first, resulting in the isotope fractionation effect. When calculating the position-specific carbon value of propane, it is necessary to set, based on multiple pyrolysis products, an isotope fractionation model, in which multiple fractionation values should be introduced. The calculation is cumbersome and complicated, affecting the accuracy of the testing results of the position-specific carbon isotope of propane.

In view of the technical problems existing in the prior arts, a testing system and method for improving the propane pyrolysis rate and simplifying the calculation of the position-specific carbon isotope value of propane is required in order to meet the needs of scientific research and production.

### SUMMARY OF THE INVENTION

The present invention proposes a method for testing position-specific carbon isotope of propane, aiming to solve the technical problem of complicated and inaccurate testing of the position-specific carbon isotope of propane in the prior arts.

The present invention further proposes a system for testing position-specific carbon isotope of propane, which can perform the method for testing position-specific carbon isotope of propane according to the present invention to solve the above technical problem.

The present invention proposes a method for testing position-specific carbon isotope of propane, comprising steps of:
S1, extracting propane;
S2, causing the propane to undergo complete pyrolysis;
S3, separating pyrolysis products of the propane; and
S4, calculating position-specific carbon isotope values of the propane based on carbon isotope values of the pyrolysis products of the propane.

In one specific embodiment, in Step S2, the propane undergoes primary pyrolysis without secondary pyrolysis.

In one specific embodiment, in Step S3, the pyrolysis products of the propane contain no alkynes.

In one specific embodiment, in Step S2, the propane undergoes the complete pyrolysis by flowing through a pyrolysis device, wherein the pyrolysis device comprises a plurality of pyrolysis tubes arranged in series, adjacent two of the pyrolysis tubes connected to each other end to end.

In one specific embodiment, in Step S2, the propane flows through a filler to undergo the complete pyrolysis.

In one specific embodiment, said filler is one or more of quartz sand, quartz wool, and silica gel.

In one specific embodiment, in Step S4, a fractionation factor ε₁ and the position-specific carbon isotope values of the propane δ¹³Cₐ and δ¹³C_{b} are calculated by the following equations:

δ¹³C_{C2H4}=(δ¹³Cₐ+δ¹³C_{b}+ε₁)/2;

δ¹³C_{CH4corrected}=(m_{CH4}×δ¹³C_{CH4}+2m_{C2H6}×δ¹³C_{C2H6})/(m_{CH4}+2m_{C2H6})=δ¹³Cₐ+ε₁, and

δ¹³C_{C3H8}=(2δ¹³Cₐ+δ¹³C_{b})/3,
wherein
δ¹³Cₐ denotes a terminal carbon isotope value of the propane;
δ¹³C_{b} denotes an intermediate carbon isotope value of the propane;
δ¹³C_{C3H8} denotes an initial carbon isotope value of the propane;
δ¹³C_{C2H4} denotes a carbon isotope value of ethylene, which is one of the pyrolysis products;
δ¹³C_{CH4corrected} denotes an initial carbon isotope value of methane;
ε₁ denotes an isotopic fractionation factor associated with an isotope fractionation effect generated from a reaction of generating methane and ethylene from the propane and a reaction of decomposition of the methane and ethylene;
m_{CH4} denotes a molar yield of the pyrolysis product methane; and
m_{C2H6} denotes a molar yield of the pyrolysis product ethane.

In one specific embodiment, fractionation factors ε₂ and ε₃ are calculated by the following equations:
δ¹³C_{C3H6}=(2δ¹³Cₐ+δ¹³C_{b})/3+ε₂; and
δ¹³C_{C2H6}=δ¹³Cₐ+ε₁+ε₃,
wherein
δ¹³C_{C2H6} denotes a carbon isotope value of ethane, which is one of the pyrolysis products;
δ¹³C_{C3H6} denotes a carbon isotope value of propylene, which is one of the pyrolysis products;
ε₂ denotes an isotopic fractionation factor associated with an isotope fractionation effect generated from a reaction of generating propylene from the propane; and
ε₃ denotes an isotopic fractionation factor associated with an isotope fractionation effect generated from a reaction of generating ethane from terminal methyl radicals.

The present invention further proposes a system for testing position-specific carbon isotope of propane, comprising:
a first chromatograph for extracting the propane from natural gas;
a pyrolysis device arranged downstream of the first chromatograph, for causing the propane to undergo the complete pyrolysis;
a second chromatograph arranged downstream of the pyrolysis device, for separating the products from each other after the complete pyrolysis of the propane; and
an isotope mass spectrometer arranged downstream of the second chromatograph, for monitoring carbon isotopes of the pyrolysis products.

In one specific embodiment, the pyrolysis device comprises a heating furnace for providing a temperature required for propane pyrolysis reaction, and at least one pyrolysis tube arranged within the heating furnace for the propane to flow through.

In one specific embodiment, a filler is arranged within the pyrolysis tube.

In one specific embodiment, a plurality of pyrolysis tubes is arranged in series inside the heating furnace, wherein adjacent two of the pyrolysis tubes are connected to each other end to end.

In one specific embodiment, both ends of each said pyrolysis tube extend out of the heating furnace, wherein adjacent two of the pyrolysis tubes are connected to each other via U-shaped connectors.

In one specific embodiment, said second chromatograph comprises a second chromatographic column, wherein the second chromatographic column is connected at a downstream side thereof to the isotope mass spectrometer for measuring the isotopes of the pyrolysis products of the propane.

In one specific embodiment, said second chromatograph further comprises a first chromatographic column, wherein an FID is arranged downstream of the first chromatographic column for measuring compositions and content of the pyrolysis products of the propane.

In one specific embodiment, said system for testing position-specific carbon isotope of propane further comprises a four-way valve, wherein two valve ports of the four-way valve are connected to the first chromatograph and the pyrolysis device respectively, while other two valve ports of the four-way valve are configured to vent and provide a carrier gas, respectively.

Compared with the prior arts, the present application has the following advantages.

The system for testing position-specific carbon isotope of propane is able to realize the separation of propane from natural gas, high-temperature pyrolysis, and the testing of the contents and isotope values of the pyrolysis products. The system is characterized by a high propane pyrolysis rate which can reach 100%, thus realizing a simple calculation of the position-specific carbon isotope value of propane.

The method for testing position-specific carbon isotope of propane according to the present invention does not require introducing fractionation equations to complete the calculation. Therefore, the isotope fractionation effect due to incomplete propane pyrolysis can be eliminated, so that the calculation will not be affected, avoiding inaccurate calculation results.

The system for testing position-specific carbon isotope of propane according to the present invention includes 3 to 5 pyrolysis tubes in the heating furnace, without increasing the length of the pyrolysis tubes and that of the heating furnace. Fillers can be loaded into the pyrolysis tubes, thus increasing paths for the propane to flow through the pyrolysis tubes and prolonging the pyrolysis reaction duration at least 3 to 5 times. In addition, a low pyrolysis temperature can be selected while ensuring the pyrolysis rate, in order to avoid secondary pyrolysis reaction of the propane pyrolysis products and reduce the isotope fractionation effect.

In the method for testing position-specific carbon isotope of propane according to the present invention, the total carbon isotope fractionation value due to incomplete propane pyrolysis in the conventional pyrolysis method is 0. Therefore, there is no need to introduce the total carbon isotope fractionation value and a complex relationship between the pyrolyzed propane and the pyrolysis products thereof. Only three equations are needed in the present invention to calculate the position-specific carbon isotope of propane value, which greatly simplifies the calculation and improves the analysis efficiency.

### BRIEF DESCRIPTION OF THE DRAWINGS

The present invention will be described below with reference to the accompanying drawings.

FIG. 1 schematically shows an embodiment of a system for testing position-specific carbon isotope of propane according to the present invention.

FIG. 2 schematically shows a procedure of pyrolysis reaction of propane and characteristics of products.

### LIST OF REFERENCE SIGNS

10. system for testing position-specific carbon isotope of propane; 100. first chromatograph; 101. four-way valve; 11. first valve port; 12. second valve port; 13. third valve port; 14. fourth valve port; 20. pyrolysis device; 200. heating furnace; 201. through hole; 202. pyrolysis tube; 203. filler; 204. two-way connector; 205. connecting tube; 301. three-way valve; 300. second chromatograph; 302. first chromatographic column; 303. FID; 304. second chromatographic column; 400. isotope mass spectrometer.

In the present application, all accompanying drawings are schematic ones, provided to illustrate the principle of the present invention merely, and are not necessarily drawn to actual scale.

### DETAILED DESCRIPTION OF EMBODIMENTS

The present invention will be described below with reference to the accompanying drawings.

It should be noted that, in the present invention, a source of propane according to the present invention is described as “upstream”, “front end” or similar expressions, while a destination of the propane is described as “downstream”, “rear end” or similar expressions.

In the prior arts, calculations for testing the position-specific carbon isotope of propane are described as follows.

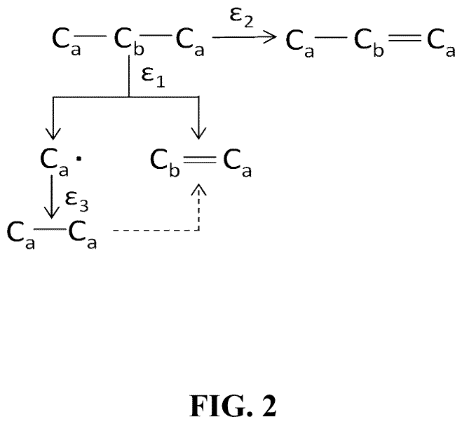

FIG. 2 shows a procedure of pyrolysis reaction of the propane and characteristics of the products.

Fractionation factors of propane pyrolysis products are defined as ε₁, ε₂ and ε₃, respectively, wherein ε₁ is associated with the isotope fractionation effect generated from the reaction of generating methane and ethylene from the propane and the reaction of decomposition of the methane and ethylene; ε₂ is associated with the isotope fractionation effect generated from the reaction of generating propylene from the propane; and ε₃ is associated with the isotope fractionation effect generated from the reaction of generating ethane from terminal methyl radicals.

The relationships between the propane and its pyrolysis products including methane, ethane, ethylene and propylene are described as follows.

$${C}_{a} - {C}_{b} - {C}_{a} {\to }^{{ε}_{1}} {C}_{a} + {C}_{a} = {C}_{b} ; \qquad Equation 1$$

$$2 {C}_{a} {\to }^{{ε}_{3}} {C}_{a} - {C}_{a} ; and \qquad Equation 2$$

$${C}_{a} - {C}_{b} - {C}_{a} {\to }^{{ε}_{2}} {C}_{a} - {C}_{a} = {C}_{b} . \qquad Equation 3$$

Therefore, the relationships between the isotope values of the propane pyrolysis products and each fractionation factor, a terminal carbon isotope value, and an intermediate carbon isotope value can be expressed using the following equations.

δ¹³C_{CH4corrected}=δ¹³Cₐ+ε₁, Equation 4

δ¹³C_{C2H4}=(δ¹³Cₐ+δ¹³C_{b}+ε₁)/2, Equation 5

δ¹³C_{C3H6}=(2δ¹³Cₐ+δ¹³C_{b})/3+ε₂, and Equation 6

δ¹³C_{C2H6}=δ¹³Cₐ+ε₁+ε₂, Equation 7
wherein:
δ¹³C_{CH4corrected} denotes an initial carbon isotope value of methane (including carbon atoms of ethane), unknown and to be solved;
δ¹³C_{C2H4} denotes a carbon isotope value of pyrolysis product ethylene, measured;
δ¹³C_{C3H6} denotes a carbon isotope value of pyrolysis product propylene, measured;
δ¹³C_{C2H6} denotes a carbon isotope value of pyrolysis product ethane, measured;
δ¹³Cₐ denotes the terminal carbon isotope of propane, unknown and to be solved;
δ¹³C_{b} denotes the intermediate carbon isotope of propane, unknown and to be solved;
ε₁ denotes an isotopic fractionation factor associated with the isotope fractionation effect generated from the reaction of generating methane and ethylene from the propane and the reaction of decomposition of the methane and ethylene, unknown and to be solved;
ε₂ denotes an isotopic fractionation factor associated with the isotope fractionation effect generated from the reaction of generating propylene from the propane, unknown and to be solved; and
ε₃ denotes an isotopic fractionation factor associated with the isotope fractionation effect generated from the reaction of generating ethane from terminal methyl radicals, unknown and to be solved.

The relationship between a corrected isotope value of the methane and the pyrolysis products methane and ethane is as follows.

δ¹³C_{CH4corrected}=(m_{CH4}×δ¹³C_{CH4}+2m_{C2H6}×δ¹³C_{C2H6})/(m_{CH4}+2m_{C2H6}), Equation 8
wherein:
δ¹³C_{CH4} denotes a carbon isotope value of the pyrolysis product methane, measured;
m_{CH4} denotes a molar yield of the pyrolysis product methane, unknown and to be solved; and
m_{C2H6} denotes a molar yield of the pyrolysis product ethane, unknown and to be solved.

Therefore, it can be determined, based on Equations 4 and 8, that δ¹⁵C_{CH4corrected}=(m_{CH4}×δ¹³C_{CH4}+2m_{C2H6}×δ¹³C_{C2H6})/(m_{CH4}+2m_{C2H6})=δ¹³Cₐ+ε₁.

Based on the law of conservation of mass, it can be determined that

C₃H₈→m_{CH4}·CH₄+m_{C2H4}·C₂H₄+m_{C3H6}·C₃H₆+m_{C2H6}·C₂H₆.

Based on the law of conservation of mass, a relationship between the pyrolyzed propane isotope value and the product isotope value is as follows.

δ¹³C_{C3H8pyrolyzed}=(X_{CH4}·δ¹³C_{CH4}+X_{C2H4}·δ¹³C_{C2H4}+X_{C2H6}·δ¹³C_{C2H6}+X_{C3H6}·δ¹³C_{C3H6}), Equation 9
wherein:
X_{CH4} denotes a mass fraction of carbon in the pyrolysis product methane, unknown and to be solved;
X_{C2H4} denotes a mass fraction of carbon in the pyrolysis product ethylene, unknown and to be solved;
X_{C2H6} denotes a mass fraction of carbon in the pyrolysis product ethane, unknown and to be solved; and
X_{C3H6} denotes a mass fraction of carbon in the pyrolysis product propylene, unknown and to be solved.

The mass fractions of carbon in the above pyrolysis products are calculated as follows.

$${X}_{i} = \frac{{m}_{i} \cdot {n}_{i}}{\sum {m}_{i} \cdot {n}_{i}} = \frac{{m}_{i} \cdot {n}_{i}}{{m}_{C H 4} \cdot 1 + {m}_{C 2 H 4} \cdot 2 + {m}_{C 2 H 6} \cdot 2 + {m}_{C 3 H 6} \cdot 3} . \qquad Equation 10$$

Since the propane pyrolysis rate in the prior arts is about 50%, the fractionation Δδ¹³C of the carbon isotope values of the pyrolyzed propane and the initial propane can be expressed respectively as follows.

Δδ¹³C=δ¹³C_{C3H8pyrolyzed}−δ¹³C_{C3H8initial}=(X_{CH4}+X_{C2H6})·ε₁+X_{C2H4}·ε₁/2+X_{C3H6}·ε₂, Equation 11
wherein δ₁₃C_{C3H8initial} is detected by an isotope mass spectrometer at room temperature.

Equation 5×2+(Equation 4 to Equation 6)×3→2ε₁−3ε₂=δ¹³C_{CH4corrected}+2δ¹³C_{C2H4}−3δ¹³C_{C3H6}. Equation 12

Based on Equations 11 and 12, the following equation can be obtained.

$${ε}_{1} = \frac{\begin{matrix}{Δδ}^{13} C + {X}_{C 3 H 6} \times \\ ( \frac{1}{3} {δ}^{13} {C}_{CH 4 corrected} + \frac{2}{3} {δ}^{13} {C}_{C 2 H 4} - {δ}^{13} {C}_{C 3 H 6} )\end{matrix}}{{X}_{CH 4} + \frac{1}{2} {X}_{C 2 H 4} + {X}_{C 2 H 6} + \frac{2}{3} {X}_{C 3 H 6}} . \qquad Equation 13$$

Based on Equation 4, the following equation can be obtained.

δ¹³Cₐ=δ¹³C_{CH4corrected}−ε₁. Equation 14

By substituting δ¹³C_{CH4corrected} in Equation 8 and ε₁ in Equation 13 into Equation 14, δ¹³Cₐ can be obtained.

Based on Equations 5 and 14, the following equation can be obtained.

δ¹³C_{b}=2×δ¹³C_{C2H4}−δ¹³C_{CH4corrected}. Equation 15

By substituting δ¹³C_{CH4corrected} in Equation 8 into Equation 15, δ¹³C_{b} can be calculated.

In summary, the calculation for testing the position-specific carbon isotope in the prior arts require solving Equations 4 to 6 and 8 to 15 (wherein the fractionation factor ε₃ can be calculated by Equation 7), in order to calculate the terminal carbon isotope δ¹³Cₐ and the intermediate carbon isotope δ¹³C_{b}.

In the above procedures, a large number of measurements or calculations are required, which is cumbersome and intensive, hindering the progress of the research.

Therefore, in order to solve the above technical problem of the calculation for testing the position-specific carbon isotope of propane, the present invention proposes a method for testing position-specific carbon isotope of propane.

In order to reduce the workload of testing position-specific carbon isotope of propane, the inventors of the present invention conducted in-depth research on the existing calculation methods and obtained a new method for testing position-specific carbon isotope of propane. This method according to the present application can simplify the calculation for testing position-specific carbon isotope of propane, ensuring accurate calculation with minimal errors.

The inventors of the present invention have discovered that if complete pyrolysis of propane is achieved (in the context, “complete pyrolysis” is defined as a ratio of a molar amount of pyrolyzed propane to a molar amount of initial propane ≥95%), the carbon isotope fractionation value of the propane can be approximately considered to be 0 in the calculation. That is, the difference between the carbon isotope value of the pyrolyzed propane and that of the initial propane is 0, thereby significantly simplifying the entire calculation procedure. The details are provided as follows.

With the complete pyrolysis of the propane, Equation 11 in the prior arts is: Δδ¹³C=δ¹³C_{C3H8pyrolyzed}−δ¹³C_{C3H8initial}=0. Thus in the calculation, there is no need to use Equations 6, 7 and 9 to 15 in the prior arts. Only three equations are needed, namely:

δ¹³C_{C2H4}=(δ¹³Cₐ+δ¹³C_{b}+ε₁)/2; Equation 5 in the prior arts

δ¹³C_{CH4corrected}=(m_{CH4}×δ¹³C_{CH4}+2m_{C2H6}×δ¹³C_{C2H6})/(m_{CH4}+2m_{C2H6})=δ¹³Cₐ+ε₁; and Equations 8 and 4 in the prior arts

δ¹³C_{C3H8}=(2δ¹³Cₐ+δ¹³C_{b})/3. New Equation 16

With the above three equations, the terminal carbon isotope δ¹³Cₐ and the intermediate carbon isotope δ¹³C_{b} can be both obtained, wherein δ¹³C_{C3H8} denotes the carbon isotope value of propane.

The calculation results of the terminal carbon isotope δ¹³Cₐ and the intermediate carbon isotope δ¹³C_{b} are as follows.

δ¹³Cₐ=(3δ¹³C_{C3H8}−δ¹³C_{b})/2; and

δ¹³C_{b}=2δ¹³C_{C2H4}−δ¹³C_{CH4corrected},
wherein δ¹³C_{C3H8} and δ¹³C_{C2H4} can be directly measured by the isotope mass spectrometer, and δ¹³C_{CH4corrected} can be calculated with Equation 8.

### Embodiment 1

According to the present invention, a system 10 for testing position-specific carbon isotope of propane is provided for performing the method for testing position-specific carbon isotope of propane according to the present invention.

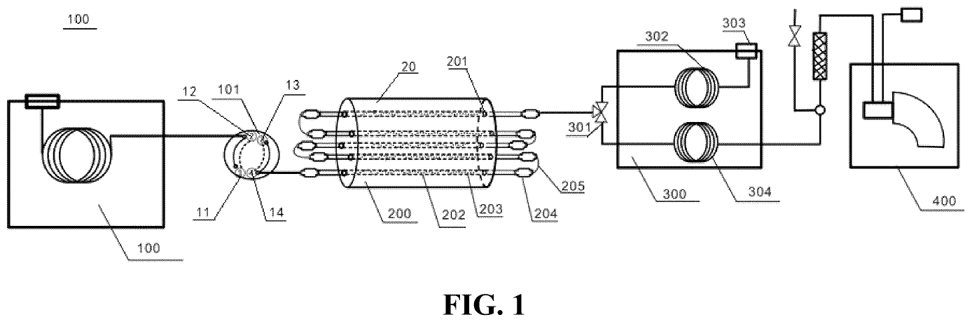

As shown in FIG. 1, the system 10 for testing position-specific carbon isotope of propane includes a first chromatograph 100, a pyrolysis device 20, a second chromatograph 300, and an isotope mass spectrometer 400, which are sequentially arranged from an upstream side to a downstream side of the system. The first chromatograph 100 is connected to natural gas at an upstream side thereof, for extracting propane from the natural gas. The first chromatograph 100 is further configured to transmit the propane extracted from the natural gas to the pyrolysis device 20, which is configured for achieving complete pyrolysis of the propane. After the propane is completely pyrolyzed in the pyrolysis device 20, it flows into the second chromatograph 300, which separates the products of the propane obtained after complete pyrolysis from each other. Finally, the separated pyrolysis products enter the isotope mass spectrometer 400, which is configured to measure the carbon isotopes of the pyrolysis products.

According to the present invention, in one preferred embodiment, when the propane is completely pyrolyzed in the pyrolysis device 20, only primary pyrolysis occurs but no secondary pyrolysis occurs. It should be noted that, in the present invention, no secondary pyrolysis means that primary pyrolysis products will not be pyrolyzed again to generate alkynes. Therefore, in the present invention, whether the secondary pyrolysis of the propane occurs is determined by detecting whether alkynes exist in the propane pyrolysis products. When the propane pyrolysis products contain alkynes, it is determined that the propane undergoes the secondary pyrolysis. Conversely, when the propane pyrolysis products do not contain alkynes, it is determined that the propane does not undergo the secondary pyrolysis.

According to the present invention, in one specific embodiment, the pyrolysis device 20 includes a heating furnace 200 and at least one pyrolysis tube 202. The heating furnace 200 is in a cylindrical shape, with a central axis thereof arranged in a horizontal direction. Axial through holes 201 are provided in the heating furnace 200, corresponding in number to the pyrolysis tubes 202. The through holes 201 penetrate the heating furnace 200, and diameters of the through holes 201 are larger than outer diameters of the pyrolysis tubes 202, allowing the pyrolysis tubes 202 to be inserted through the through holes 201. The propane flows in the pyrolysis tubes 202, which are heated by the heating furnace 200 to provide the temperature required for the propane pyrolysis reaction. Preferably, a heating temperature of the heating furnace 200 ranges from 740 to 820° C.

In one preferred embodiment, the pyrolysis tubes 202 are made of ceramic or quartz material. Further, the pyrolysis tubes 202 are made of non-porous alumina material. The heating furnace 200 is made of solid high-temperature resistant material.

In one specific embodiment, a filler 203 is provided in the pyrolysis tubes 202. The filler 203 is used to increase the pyrolysis reaction rate of the propane, prolong the residence time of the propane within the pyrolysis tubes 202, and increase the pyrolysis conversion rate of the propane. Such arrangement allows for the complete pyrolysis of the propane.

Preferably, the filler 203 may be quartz sand, quartz wool, silica gel, etc.

In one specific embodiment, a plurality of through holes 201 is provided in the heating furnace 200, wherein one pyrolysis tube 202 is provided in each of the through holes 201, and two adjacent pyrolysis tubes 202 are connected to each other in series.

As shown in FIG. 1, both ends of each pyrolysis tube 202 extend beyond a length of the heating furnace 200, so that two adjacent pyrolysis tubes 202 can be connected to each other in series. Specifically, two adjacent pyrolysis tubes 202 are connected to each other via a connecting tube 205, so that the plurality of pyrolysis tubes 202 is connected in series. With such arrangement, the flow path of the propane in the heating procedure is extended, thus prolonging the heating time of the propane. The propane not pyrolyzed in one pyrolysis tube 202 can continue to be introduced into the next pyrolysis tube 202 for pyrolysis, thereby increasing the pyrolysis conversion rate of the propane.

In one preferred embodiment, two-way connectors 204 are provided at both ends of each pyrolysis tube 202. According to the serial sequence of the pyrolysis tubes 202, a connecting tube 205 is connected between the two-way connectors 204 of two adjacent pyrolysis tubes 202, thereby realizing the serial connection of multiple pyrolysis tubes 202.

In one specific embodiment, the second chromatograph 300 includes a second chromatographic column 304. The second chromatographic column 304 is connected to the pyrolysis tubes 202 at an upstream side thereof, and to the isotope mass spectrometer 400 at a downstream side thereof. The pyrolysis products in the pyrolysis tubes 202 are separated by the second chromatographic column 304 and then flow to the isotope mass spectrometer 400. The isotope mass spectrometer 400 is configured to monitor changes in the carbon isotope of each pyrolysis product.

In one preferred embodiment, the second chromatograph 300 further includes a first chromatographic column 302. The first chromatographic column 302 is connected to the isotope mass spectrometer 400 at an upstream side thereof, and to a hydrogen flame ionization detector (FID) 303 at a downstream side thereof. The pyrolysis products in the pyrolysis tubes 202 are separated by the first chromatographic column 302 and then flow to the FID 303. The FID 303 is configured to detect the composition and content of the hydrocarbon pyrolysis products.

In one specific embodiment, a three-way valve 301 is arranged downstream of the pyrolysis tubes 202. Two downstream outlets of the three-way valve 301 are connected to the first chromatographic column 302 and the second chromatographic column 304, respectively.

According to the present invention, the first chromatograph 100 is connected to the pyrolysis tubes 202 via a four-way valve 101. Specifically, the four-way valve 101 includes a first valve port 11, a second valve port 12, a third valve port 13 and a fourth valve port 14. The second valve port 12 of the four-way valve 101 is connected to an outlet of the first chromatograph 100. The fourth valve port 14 of the four-way valve 101 is connected to an inlet of the pyrolysis tube 202. The third valve port 13 of the four-way valve 101 is connected to a vent valve (not shown), through which non-propane gases separated from the natural gas by the first chromatograph 100 can be discharged. The first valve port 11 of the four-way valve 101 is connected to a helium pressure regulating valve (not shown), through which carrier gas can be supplied to the pyrolysis tubes 202 to facilitate the flow of the propane therein.

δ¹³C_{C3H8initial} is detected by the isotope mass spectrometer 400 at room temperature.

It should be noted that the helium as a carrier gas to facilitate the flow of propane is only one embodiment of the present invention, and is not intended to limit the scope of protection of the present invention. One skilled in the art may choose other carrier gas sources based on the present invention and actual conditions.

In one preferred embodiment, the helium pressure regulating valve controls a flow rate of the carrier gas to be 0.8 to 2 ml/min.

### Embodiment 2

In this embodiment, the outlet of the first chromatograph 100 is connected to the inlet of the pyrolysis tube 202 through the four-way valve 101, while the other two valve ports of the four-way valve 101 are connected to the helium pressure regulating valve and the vent valve, respectively. An outlet of the pyrolysis tube 202 is connected to the three-way valve 301. Two outlets of the three-way valve 301 are connected to the first chromatographic column 302 and the second chromatographic column 304, respectively. An outlet of the first chromatographic column 302 is connected to the FID, and an outlet of the second chromatographic column 304 is connected to the isotope mass spectrometer 400.

In this embodiment, a pyrolysis tube 202 is arranged in the heating furnace 200. The pyrolysis tube 202 has a length of 320 mm and an inner diameter of 1.5 mm. A middle portion of the pyrolysis tube 202 is filled therein with quartz wool or quartz sand with a length of 5 cm.

The experimental procedure is described as follows.

Natural gas is injected into an inlet of the first chromatograph 100, and an analysis program of the first chromatograph 100 is set to separate the natural gas. The first chromatograph 100 will separate out other components prior to propane. In this case, said other components before the outflow of propane can be vented through the vent valve connected to the four-way valve 101.

When the propane flows out, the carrier gas can be introduced into the pyrolysis tubes 202 through the helium pressure regulating valve connected to the four-way valve 101, thereby diverting the propane into the pyrolysis tubes 202. The flow rate of the carrier gas is 1 ml/min.

The heating furnace 200 is heated to 820° C. The propane is pyrolyzed at the temperature of the heating furnace 200 while flowing within the pyrolysis tubes 202.

The products of the propane pyrolysis, after flowing out of the pyrolysis tubes 202, pass through the three-way valve 301 to enter the first chromatographic column 302 and the second chromatographic column 304 of the second chromatograph 300 for separation. The pyrolysis products separated by the first chromatographic column 302 are detected by the FID 303 for the composition and the content thereof, and the pyrolysis products separated by the second chromatographic column 304 are monitored by the isotope mass spectrometer 400 for the changes in the carbon isotope.

δ¹³C_{C3H8initial} is detected by the isotope mass spectrometer 400 at room temperature.

Peak areas of the pyrolysis products and the propane not pyrolyzed are detected by the gas chromatograph and divided by the corresponding molar masses to obtain the molar amount of each compound, which is then multiplied by the number of carbon atoms in each compound to obtain the molar amount of carbon atoms of each compound. The molar amount of the pyrolyzed propane is calculated by dividing a sum of the molar amount of the carbon atoms of the pyrolysis products by 3. Then, the molar amount of the pyrolyzed propane is divided by a sum of the molar amount of the pyrolyzed propane and the propane not pyrolyzed to obtain the propane pyrolysis rate. The result shows that the propane pyrolysis rate is 95%.

The molar amount of the pyrolysis product calculated above is divided by the molar amount of the pyrolyzed propane to calculate the molar yield of each pyrolysis product.

The pyrolysis products and the propane isotope values δ¹³C_{C2H4}, δ¹³C_{CH4}, δ¹³C_{C2H6} and δ¹³C_{C3H8} detected by the isotope mass spectrometer are substituted into the following equations.

δ¹³C_{C2H4}=(δ¹³Cₐ+δ¹³C_{b}+ε₁)/2. Equation 5

δ¹³C_{CH4corrected}=(m_{CH4}×δ¹³C_{CH4}+2m_{C2H6}×δ¹³C_{C2H6})/(m_{CH4}+2m_{C2H6})=δ¹³Cₐ+ε₁. Equation 8 (combined with Equation 4)

δ¹³C_{C3H8}=(2δ¹³Cₐ+δ¹³C_{b})/3. Equation 16

After calculation, δ¹³Cₐ=−32.3‰ and δ¹³C_{b}=−17.7‰ are obtained.

The same experimental data are calculated according to the method in the prior arts (considering a pyrolysis rate of 95%), and δ¹³Cₐ=−32.4‰ and δ¹³C_{b}=−17.7‰ are obtained. The experimental error is only 0.1‰ (for δ¹³Cₐ).

### Embodiment 3

The rate of the carrier gas flow is 0.8 ml/min. Two pyrolysis tubes 202 connected in series are arranged in the heating furnace 200. Each pyrolysis tube 202 has a length of 320 mm and an inner diameter of 0.5 mm. The temperature of the heating furnace 200 is 820° C. Other technical features are the same as those in Embodiment 2.

Peak areas of the pyrolysis products and the propane not pyrolyzed are detected by the gas chromatograph to calculate the molar amount of the carbon atoms of each compound. The molar amount of the pyrolyzed propane is calculated by dividing the sum of the molar amount of carbon atoms of the pyrolysis products by 3. Then, the molar amount of the pyrolyzed propane is divided by the sum of the molar amount of the pyrolyzed propane and the propane not pyrolyzed to obtain the propane pyrolysis rate. The result shows that the propane pyrolysis rate is 98%.

The molar amount of the pyrolysis products calculated above is divided by the molar amount of the pyrolyzed propane to obtain the molar yield of each pyrolysis product. The pyrolysis products and the propane isotope values δ¹³C_{C2H4}, δ¹³C_{CH4}, δ¹³C_{C2H6} and δ¹³C_{C3H8} detected by the isotope mass spectrometer are substituted into the following equations.

δ¹³C_{C2H4}=(δ¹³Cₐ+δ¹³C_{b}+ε₁)/2. Equation 5

δ¹³C_{CH4corrected}=(m_{CH4}×δ¹³C_{CH4}+2m_{C2H6}×δ¹³C_{C2H6})/(m_{CH4}+2m_{C2H6}). Equation 8

δ¹³C_{C3H8}=(2δ¹³Cₐ+δ¹³C_{b})/3. Equation 16

After calculation, δ¹³Cₐ=−32.5‰ and δ¹³C_{b}=−17.5‰ are obtained.

The same experimental data are calculated according to the method in the prior arts (considering a pyrolysis rate of 98%), and δ¹³Cₐ=−32.4‰ and δ¹³C_{b}=−17.5‰ are obtained. The experimental error is only 0.1‰ (for δ¹³Ca).

### Embodiment 4

The flow rate of the carrier gas is 2 ml/min. Three pyrolysis tubes 202 are arranged in the heating furnace 200. Each pyrolysis tube 202 has a length of 320 mm and an inner diameter of 1.5 mm. A middle portion of the pyrolysis tube 202 is filled therein with quartz wool or quartz sand with a length of 10 cm. The temperature of the heating furnace 200 is 820° C. Other technical features are the same as those in Embodiment 2.

Peak areas of the pyrolysis products and the propane not pyrolyzed are detected by the gas chromatograph to obtain the molar amount of the carbon atoms of each compound. The molar amount of the pyrolyzed propane is calculated by dividing the sum of the molar amount of the carbon atoms of the pyrolysis products by 3. Then, the molar amount of the pyrolyzed propane is divided by the sum of the molar amount of the pyrolyzed propane and the propane not pyrolyzed to obtain the propane pyrolysis rate. The result shows that the propane pyrolysis rate is 96%.

The molar amount of the pyrolysis products calculated above is divided by the molar amount of the pyrolyzed propane to calculate the molar yield of each pyrolysis product.

The pyrolysis products and the propane isotope values δ¹³C_{C2H4}, δ¹³C_{CH4}, δ¹³C_{C2H6} and δ¹³C_{C3H8} detected by the isotope mass spectrometer are substituted into the following equations.

δ¹³C_{C2H4}=(δ¹³Cₐ+δ¹³C_{b}+ε₁)/2. Equation 5

δ¹³C_{CH4corrected}=(m_{CH4}×δ¹³C_{CH4}+2m_{C2H6}×δ¹³C_{C2H6})/(m_{CH4}+2m_{C2H6}). Equation 8

δ¹³C_{C3H8}=(2δ¹³Cₐ+δ¹³C_{b})/3. Equation 16

After calculation, δ¹³Cₐ=−32.4‰ and δ¹³C_{b}=−17.6‰ are obtained.

The same experimental data are calculated according to the method in the prior arts (considering a pyrolysis rate of 96%), and δ¹³Cₐ=−32.5‰ and δ¹³C_{b}=−17.6% ‰ are obtained. The experimental error is only 0.1% ‰ (for δ¹³Cₐ).

### Embodiment 5

The temperature of the heating furnace 200 is 740° C. The flow rate of the carrier gas is 1.0 ml/min. Five pyrolysis tubes 202 are arranged in series within the heating furnace 200. Each pyrolysis tube 202 has a length of 320 mm and an inner diameter of 1.5 mm. A middle portion of the pyrolysis tube 202 is filled therein with quartz wool or quartz sand with a length of 10 cm. Other technical features are the same as those in Embodiment 2.

Peak areas of the pyrolysis products and the propane not pyrolyzed are detected by the gas chromatograph to calculate the molar amount of the carbon atoms of each compound. The molar amount of the pyrolyzed propane is calculated by dividing the sum of the molar amount of the carbon atoms of the pyrolysis products by 3. Then, the molar amount of the pyrolyzed propane is divided by the sum of the molar amount of the pyrolyzed propane and the propane not pyrolyzed to obtain the propane pyrolysis rate. The result shows that the propane pyrolysis rate is 97%.

The molar amount of the pyrolysis products calculated above is divided by the molar amount of the pyrolyzed propane to calculate the molar yield of each pyrolysis product.

The pyrolysis products and the propane isotope values δ¹³C_{C2H4}, δ¹³C_{CH4}, δ¹³C_{C2H6} and δ¹³C_{C3H8} detected by the isotope mass spectrometer are substituted into the following equations.

δ¹³C_{C2H4}=(δ¹³Cₐ+δ¹³C_{b}+ε₁)/2. Equation 5

δ¹³C_{CH4corrected}=(m_{CH4}×δ¹³C_{CH4}+2m_{C2H6}×δ¹³C_{C2H6})/(m_{CH4}+2m_{C2H6}). Equation 8

δ¹³C_{C3H8}=(2δ¹³Cₐ+δ¹³C_{b})/3. Equation 16

After calculation, δ¹³Cₐ=−32.6‰ and δ¹³C_{b}=−17.5‰ are obtained.

The same experimental data are calculated according to the method in the prior arts (considering a pyrolysis rate of 97%), and δ¹³Cₐ=−32.5‰ and δ¹³C_{b}=−17.5‰ are obtained. The experimental error is only 0.1‰ (for δ¹³Cₐ).

### Embodiment 6

The temperature of the heating furnace 200 is 750° C. Other technical features are the same as those in Embodiment 5.

Peak areas of the pyrolysis products and the propane not pyrolyzed are detected by the gas chromatograph to obtain the molar amount of the carbon atoms of each compound. The molar amount of the pyrolyzed propane is calculated by dividing the sum of the molar amount of the carbon atoms of the pyrolysis products by 3. Then, the molar amount of the pyrolyzed propane is divided by the sum of the molar amount of the pyrolyzed propane and the propane not pyrolyzed to obtain the propane pyrolysis rate. The result shows that the propane pyrolysis rate is 97%.

The molar amount of the pyrolysis product calculated above is divided by the molar amount of the pyrolyzed propane to calculate the molar yield of each pyrolysis product.

The pyrolysis products and the propane isotope values δ¹³C_{C2H4}, δ¹³C_{CH4}, δ¹³C_{C2H6} and δ¹³C_{C3H8} detected by the isotope mass spectrometer are substituted into the following equations.

δ¹³C_{C2H4}=(δ¹³Cₐ+δ¹³C_{b}+ε₁)/2. Equation 5

δ¹³C_{CH4corrected}=(m_{CH4}×δ¹³C_{CH4}+2m_{C2H6}×δ¹³C_{C2H6})/(m_{CH4}+2m_{C2H6}). Equation 8

δ¹³C_{C3H8}=(2δ¹³Cₐ+δ¹³C_{b})/3. Equation 16

After calculation, δ¹³Cₐ=−32.5‰ and δ¹³C_{b}=−17.6‰ are obtained.

The same experimental data are calculated according to the method in the prior arts (considering a pyrolysis rate of 97%), and δ¹³Cₐ=−32.4‰ and δ¹³C_{b}=−17.6‰ are obtained. The experimental error is only 0.1‰ (for δ¹³Cₐ).

It can be seen from the above embodiments that the method for testing position-specific carbon isotope of propane according to the present invention does not require introducing complex equations due to incomplete propane pyrolysis, as well as the total carbon isotope fractionation value and fractionation equations. Only three equations are needed to calculate the position-specific carbon isotope value of propane, which simplifies the calculation with minimal errors and improves the analysis efficiency. Moreover, since there is no need to introduce the fractionation equations in the calculation, the isotope fractionation effect due to incomplete propane pyrolysis can be eliminated, so that the calculation will not be affected, avoiding inaccurate calculation results.

It should be understood that in the present invention, the terms “first” and “second” are used for illustrative purposes only, and are not intended to indicate or imply relative importance or implicitly specify the number of technical features indicated. Thus, the technical features defined with the terms “first” or “second” may explicitly or implicitly include one or more such technical features. In the description of the present invention, “a plurality of” means two or more, unless otherwise specified.

In the present invention, unless otherwise specified or defined, the phrases “mount”, “connect”, “attach”, “fix” and the like, should be understood in a broad sense, and may be understood as, for example, fixed connections, detachable connections, or integral connections; mechanical or electrical connections; direct connections or indirect connections via intermediate structure; or interior communication between two elements. The specific meanings of the above phrases in the present invention can be understood by one skilled in the art in accordance with specific conditions.

The phrases “an embodiment”, “some embodiments”, “example”, “specific example” or “some examples” as mentioned in the description mean that the particular features, structures, materials or characteristics described in conjunction with the embodiment or example are included in at least one embodiment or example of the present invention. Thus, the above illustrative phrases described throughout the description do not necessarily refer to the same embodiment or example. Moreover, the particular features, structures, materials, or characteristics described herein may be combined in any one or more of the embodiments or examples in a suitable manner.

Finally, it should be noted that the foregoing description is merely illustrative of preferred embodiments of the present invention, and is not intended to restrict the present invention. Although the present invention is described in detail with reference to the above embodiments, it is still possible for one skilled in the art to modify the technical solutions defined in the above embodiments or to replace some of the technical features with equivalent ones. Any modifications, equivalent substitutions, improvements, and the like falling within the spirit and principles of the present invention are intended to be included within the scope of protection of the present invention.

1. A method for testing position-specific carbon isotope of propane, comprising steps of:
S1, extracting propane;
S2, causing the propane to undergo complete pyrolysis;
S3, separating pyrolysis products of the propane; and
S4, calculating position-specific carbon isotope values of the propane based on carbon isotope values of the pyrolysis products of the propane.

2. The method for testing position-specific carbon isotope of propane according to claim 1, characterized in that in Step S2, the propane undergoes primary pyrolysis without secondary pyrolysis.

3. The method for testing position-specific carbon isotope of propane according to claim 2, characterized in that in Step S3, the pyrolysis products of the propane contain no alkynes.

4. The method for testing position-specific carbon isotope of propane according to claim 1, characterized in that in Step S2, the propane undergoes the complete pyrolysis by flowing through a pyrolysis device, wherein the pyrolysis device comprises a plurality of pyrolysis tubes arranged in series, adjacent two of the pyrolysis tubes connected to each other end to end.

5. The method for testing position-specific carbon isotope of propane according to claim 1, characterized in that in Step S2, the propane flows through a filler to undergo the complete pyrolysis.

6. The method for testing position-specific carbon isotope of propane according to claim 5, characterized in that said filler is one or more of quartz sand, quartz wool, and silica gel.

7. The method for testing position-specific carbon isotope of propane according to claim 1, characterized in that in Step S4, a fractionation factor ε₁ and the position-specific carbon isotope values of the propane δ¹³Cₐ and δ¹³C_{b} are calculated by the following equations:
δ¹³C_{C2H4}=(δ¹³Cₐ+δ¹³C_{b}+ε₁)/2;
δ¹³C_{CH4corrected}=(m_{CH4}×δ¹³C_{CH4}+2m_{C2H6}×δ¹³C_{C2H6})/(m_{CH4}+2m_{C2H6})=δ¹³Cₐ+ε₁, and
δ¹³C_{C3H8}=(2δ¹³Cₐ+δ¹³C_{b})/3,
wherein
δ¹³Cₐ denotes a terminal carbon isotope value of the propane;
δ¹³C_{b} denotes an intermediate carbon isotope value of the propane;
δ¹³C_{C3H8} denotes an initial carbon isotope value of the propane;
δ¹³C_{C2H4} denotes a carbon isotope value of ethylene, which is one of the pyrolysis products;
δ¹³C_{CH4corrected} denotes an initial carbon isotope value of methane;
ε₁ denotes an isotopic fractionation factor associated with an isotope fractionation effect generated from a reaction of generating methane and ethylene from the propane and a reaction of decomposition of the methane and ethylene;
m_{CH4} denotes a molar yield of the pyrolysis product methane; and
m_{C2H6} denotes a molar yield of the pyrolysis product ethane.

8. The method for testing position-specific carbon isotope of propane according to claim 7, characterized in that fractionation factors ε₂ and ε₃ are calculated by the following equations:
δ¹³C_{C3H6}=(2δ13Cₐ+δ¹³C_{b})/3+ε₂; and
δ¹³C_{C2H6}=δ¹³Cₐ+ε₁+ε₃,
wherein
δ¹³C_{C2H6} denotes a carbon isotope value of ethane, which is one of the pyrolysis products;
δ¹³C_{C3H6} denotes a carbon isotope value of propylene, which is one of the pyrolysis products;
ε₂ denotes an isotopic fractionation factor associated with an isotope fractionation effect generated from a reaction of generating propylene from the propane; and
ε₃ denotes an isotopic fractionation factor associated with an isotope fractionation effect generated from a reaction of generating ethane from terminal methyl radicals.

9. A system for testing position-specific carbon isotope of propane for performing the method for testing position-specific carbon isotope of propane according to claim 1, comprising:
a first chromatograph (100) for extracting the propane from natural gas;
a pyrolysis device (20) arranged downstream of the first chromatograph (100), for causing the propane to undergo the complete pyrolysis;
a second chromatograph (300) arranged downstream of the pyrolysis device (20), for separating the products from each other after the complete pyrolysis of the propane; and
an isotope mass spectrometer (400) arranged downstream of the second chromatograph (300), for monitoring carbon isotopes of the pyrolysis products.

10. The system for testing position-specific carbon isotope of propane according to claim 9, characterized in that the pyrolysis device (20) comprises a heating furnace (200) for providing a temperature required for propane pyrolysis reaction, and at least one pyrolysis tube (202) arranged within the heating furnace (200) for the propane to flow through.

11. The system for testing position-specific carbon isotope of propane according to claim 10, characterized in that a filler (203) is arranged within the pyrolysis tube (202).

12. The system for testing position-specific carbon isotope of propane according to claim 10, characterized in that a plurality of pyrolysis tubes (202) is arranged in series inside the heating furnace (200), wherein adjacent two of the pyrolysis tubes (202) are connected to each other end to end.

13. The system for testing position-specific carbon isotope of propane according to claim 12, characterized in that both ends of each said pyrolysis tube (202) extend out of the heating furnace (200), wherein adjacent two of the pyrolysis tubes (202) are connected to each other via U-shaped connectors.

14. The system for testing position-specific carbon isotope of propane according to claim 9, characterized in that said second chromatograph (300) comprises a second chromatographic column (304), wherein the second chromatographic column is connected at a downstream side thereof to the isotope mass spectrometer (400) for measuring the isotopes of the pyrolysis products of the propane.

15. The system for testing position-specific carbon isotope of propane according to claim 14, characterized in that said second chromatograph (300) further comprises a first chromatographic column (302), wherein an FID (303) is arranged downstream of the first chromatographic column (302) for measuring compositions and content of the pyrolysis products of the propane.

16. The system for testing position-specific carbon isotope of propane according to claim 9, characterized in that said system further comprises a four-way valve (101), wherein two valve ports of the four-way valve (101) are connected to the first chromatograph (100) and the pyrolysis device (20) respectively, while other two valve ports of the four-way valve (101) are configured to vent and provide a carrier gas, respectively.
